(19) United States
(12) Patent Application Publication
(10) Pub. No.: US 2011/0266075 A1
(43) Pub. Date: Nov. 3, 2011

(54) Energy Generation System for Electric, Hybrid and Conventional Vehicles

(76) Inventor: Harry L. Guzelimian, Solana Beach, CA (US)

(21) Appl. No.: 13/097,025

(22) Filed: Apr. 28, 2011

Related U.S. Application Data
(60) Provisional application No. 61/328,959, filed on Apr. 28, 2010.

(51) Int. Cl. B60K 16/00

(52) U.S. Cl. 180/2.2; 180/65.21

(57) ABSTRACT

The vehicle electrical energy generation system which employs one or a plurality of fans operatively engaged with a generator or alternator to generate electrical power. Incoming wind moves past fans engaged to rotate alternators or generators and exits to a secondary conduit as moving air. The moving air is directed to one or a plurality of conduits leading to one or a plurality of moving-air employing components from a group including, a de-fogging component, a windshield defroster, a windshield de-icing component, a wind powered windshield wiper, a passenger heating system, a battery heating component, and a battery cooling compartment.

This application claims priority to U.S. Provisional Application 61/328,959 filed on Apr. 28, 2010 and incorporated herein in its entirety by this reference.

### BACKGROUND OF THE INVENTION

1. Field of the Invention

The current invention relates generally to alternative means to electrically power in real time, or charge a power storage means, for a motor vehicle. More particularly it relates to a system to harness wind energy from either of a moving vehicle, or ambient wind originating substantially any direction surrounding a stationary vehicle, to create electrical energy for storage and vehicle use. Additionally, air traversing the turbine powered generators may be employed for heating components of the vehicle, clearing a windshield, or in cold climates, for heating of a battery or surrounding compartment.

2. Prior Art

Machines used to capture wind energy have been seen as far back as 200 B.C. Modern wind turbines are used more and more commonly for large scale energy generation producing orders of magnitudes of power in the megawatts. These turbines are large in scale and require ample wind speeds to produce usable energy. Of course, scaled down versions of these behemoths can be used for less demanding energy systems. Such scaled down versions can be used to power smaller batteries such as car batteries. All moving vehicles hold great potential to capture wind energy and use it to charge its battery, as well as directly power electrical components.

U.S. Pat. No. 3,876,925 to Stoeckert teaches a vehicle roof mounted wind turbine driven generator used for recharging batteries as well as fully powering an electric vehicle. Stoeckert utilizes both the moving vehicle as well as a stationary vehicle in prevalent winds as means to power the generator. The device however is bulky in nature and does not take into account the streamline shapes of vehicles known today. Gas mileage and efficiency are important factors in today's vehicle-driven world and therefor a more streamline and efficiency driven design is desirable. Further, Stoeckert makes no accommodation for capturing wind energy from all directions of a stationary vehicle to ensure constant electrical generation while the vehicle is parked. Additionally, the recycling of waste heat energy from vehicles is another effort to increase efficiency and performance of today's automobiles through re-utilization for a secondary purpose.

As such there is an unmet need, for a device or system configured to provide electrical power generation as a supplemental or primary power source for conventional internal combustion vehicle or for an electrically powered motor vehicle. Such a system should be aerodynamic during highway transit at slow and high speeds to minimize the additional fuel required to run the system. Such a system should also be adapted in configuration to allow the fan powered generators or alternators, of a stationary vehicle to generate electrical energy through the capture of wind power from a plurality of angles relative to a parked or stationary vehicle. Still further, such a system should take advantage of the captured and already moving air exiting the fans, and employ it for secondary purposes such as heating the vehicle or parts thereof, heating batteries, and for blowing off glass surfaces to eliminate the need for wipers.

With respect to the above, before explaining at least one-preferred embodiment of the disclosed electrical energy system for a motor vehicle, in detail or in general, it is to be understood that the invention disclosed herein is not limited in its application to the details of construction and to the arrangement of the components or the steps set forth for use thereof in the following description or illustrated in the drawings. The various apparatus and methods of the disclosed vehicle electrical energy generation system with concurrent employment of exhausting airstreams, is capable of other embodiments, and of being practiced and carried out in various ways, all of which will be obvious to those skilled in the art, once the information herein is reviewed. Also, it is to be understood that the phraseology and terminology employed herein are for the purpose of description and should not be regarded as limiting.

As such, those skilled in the art will appreciate that the conception upon which this disclosure is based, may readily be utilized as a basis for designing other modes of using multiple fan-driven alternators for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

The device and method of employment herein described and disclosed, overcomes the shortcomings of prior art by providing supplemental or primary electrical power for energizing the battery on a motor vehicle. The system employs a plurality of alternator or generator engaged fans to provide for energy generation from all angles using wind or incoming air currents. Concurrently, the system employs conduits for routing captured and moving air, for operative use elsewhere on the vehicle.

Each of the fans in the system is operatively mounted in a streamlined position on the vehicle in a fashion operatively adapted to generate electricity from engaged power generation means such as alternators or generators. So positioned, the fans provide the power to rotationally operate the power generation means, but with minimal drag. Since the disclosed system also provides moving channels of exhausting air from the turbines, it additionally allows for a means to employ the airstreams to heat the vehicle or parts of it, or to blow dust, rain or snow, or to melt ice, from viewing surfaces, or to heat batteries subsequent to a warming of the moving airstreams.

The system herein employs a plurality of wind rotated fans or turbines which are in operative engagement to communicate rotation to a generator or preferably an alternator component. By employing a plurality of individual fan driven generator and alternator components, all situated about the vehicle to capture incoming airstreams from differing angles, the system will allow charging of batteries stored onboard, both during driving and while the vehicle is parked. The plurality of angles of the operatively engaged fans, also allow for power generation of the vehicle while stationary, irrespective of the direction of incoming windstreams.

Preferably each of the fan and communicating alternator generating components is in a conduit which is recessed from the exterior surface of the vehicle. The conduit will preferably have a mouth having an area larger than that of the conduit and have a funnel-like shape. During driving at speed, the funnel shaped sunken conduit will capture airstreams moving past the surface of the moving vehicles and communicate the airstream over the blades of a fan powering the alternator or generator. This generates electrical power which may be communicated using wires, to storage batteries.

By employing a funnel like mouth for the entry apertures for streams of air to power the fans, a larger area of the moving airstream is captured and funneled to a smaller cross sectional conduit housing the fan powering the alternator. Such channeling increases the air speed of the air traversing the fan blades during power generation.

Once the airstream has traversed the fans, it continues down a sealed conduit under pressure from incoming airstream pushing the fluid stream through the conduit system. This moving fluid stream of fresh air may best be communicated through conduits to provide for other functions upon the vehicle. Currently cabin heating, blowing of debris, water or snow, or melting ice from the windows, and battery warming, are three favored uses of the exiting airstreams.

When employed for heating, a conduit of air moving from its exit from the fan, is directed past a heat exchange engaged to the engine or exhaust system. In the case of the exhaust system, the heat exchanger may be the headers or exhaust pipes exiting the engine. Traversing over the heated surface of the exhaust pipes or a heat exchanger engaged thereto, the air stream is warmed considerably and may be piped to parts of the vehicle for secondary employment.

In a first use of the heated air so derived, it may be directed into the cab or driver's compartment of the vehicle to heat the interior. The exhaust pipes reach temperatures in the hundreds of degrees, so even incoming air which is freezing in temperature is sufficiently heated to provide heat to the vehicle occupants. Further, by capturing waste heat for this purpose in a moving fluid stream of air, no power robbing fans are needed to communicate the airstream to the interior of the vehicle.

In a second employment of the moving airstream, it may be heated, or not, and communicated to an exit aperture through conduits leading from the exhaust from the fans driving the alternator. The exit aperture in this mode, may be a focused air aperture adjacent to the windshield of the car. The moving air will be blown across the windshield during inclement weather to blow the rain or snow therefrom. This eliminates the need for electrically driven wipers which rob power and economy from vehicle operations.

In yet a third mode of the device and method, the air moving to the rear of the generation fans, is again coerced to a narrower conduit and accelerates due to the pressure of more incoming air in larger cross sectional volume. The air so channelized in a conduit may now be directed across a hot engine surface or across a heat exchange connected to the exhaust pipes, to an exit aperture in the interior of the vehicle adjacent to the windshield. From this point, using a nuzzled or airstream focusing conduit exit aperture, the heated airstream may be employed to defrost or de-ice the windshield in cold climates.

This heated airstream may also de-fog or clear condensation from the inside face of the windshield. Since the airstream is under pressure and moving, no fan is needed which might rob electrical power from the vehicle. Further no electric heater to warm the airstream is required, nor any communication of potentially hazardous antifreeze from the engine and into the passenger compartment in the conventional fashion.

In still yet another mode of the device, the captured and heated airstreams within the conduits of the present invention may be directed to a heat exchanger means at or near the battery compartment of the vehicle for operative heating of the battery. Due to the recent need and development of hybrid and full electric vehicles the operating temperature and efficiency of the battery greatly effect the advantages in fuel economy associated with such vehicles. At normal operative temperature a hybrid or full electric vehicle can provide fuel economy far greater than any fuel burning vehicle.

Hybrid and electric vehicle owners take great pride in not only the reduced environmental impact of such vehicles but also the savings in cost associated with fuel economy achieved by the use of electric batteries. However inclement weather such as extreme cold or heat, the range of travel promised by most manufacturers is nearly cut in half. Therefor it is the advantage of the present invention to provide heat exchanger means at or near the battery compartment.

For example in extreme cold weather, captured and heated airstreams as previously disclosed may be directed to an insulated battery compartment housing as a heat exchanger means to heat the battery to a normal operating temperature. Alternatively in extreme heat, the captured airstream driving fans of an alternator may be used to power a compressor or the like to further cool the captured air and direct it to a heat exchanger means at or near the battery compartment to effectively cool a battery as needed.

Alternatively, because the vehicle generates electrical energy while parked outside where wind powers the fans or turbines and attached electrical generation means, the system herein may be employed to heat batteries by using resistive electrical heating means such as an electric blanket. In this mode, the electrical energy generated while parking is operatively communicated to a resistive heat generation device adjacent to, or surrounding a battery. Heat so generated will maintain the battery withing operative temperature ranges which is especially important on hybrid and fully electric vehicles lest they lose a great deal of range due to chilled batteries.

In the passive mode of electrical energy generation, the system will generate electrical energy from ambient wind directed against the vehicle. The funneled intake apertures are formed such that they intake a sufficient amount of moving air to generate energy when the car is moving. But, some or all of the intake apertures can concurrently be placed at such an angle as to allow for natural wind from a plurality of approaching angles, to turn the fan blades and continue to charge vehicle batteries. For vehicles sitting in long term parking or otherwise parked for long periods, this energy generating will keep the batteries charged. Further if desired, should the vehicle be parked in the sun, the exiting airstreams may be channeled through the passenger compartment to keep it reasonably cool.

As such, the disclosed device and method maximizes the electrical energy generation of the vehicle while moving and while parked. Concurrently while moving, the airstream may be employed to heat the passenger compartment or defrost the windshield, and, while stationary, the airstream may cool a sunbaked car.

It is an object of this invention to provide an electrical energy generation system adapted to generate electrical power while the vehicle is moving.

It is a further object of this invention to provide a means to generate electrical power while the vehicle is stationary.

It is another object of this invention to provide such a vehicle electrical generation system, which also employs exhausting airstreams to heat or cool components of the vehicle or to function as air driven windshield wipers.

An additional object of this invention, is the provision of a means to generate electrical energy on a parked vehicle which may concurrently be employed to heat onboard batteries and maintain them within operative temperature ranges.

These together with other objects and advantages which become subsequently apparent reside in the details of the vehicle wind driven electrical energy generation system herein as more fully hereinafter described and claimed, with reference being made to the accompanying drawings forming a part thereof, wherein like numerals refer to like parts throughout.

### BRIEF DESCRIPTION OF DRAWING FIGURE

The figures are briefly described below, however it should be remembered that any of the various projecting or recessed fans may be employed alone or in combination with the other and the rotatable wind deflectors may be included with any employed fan receiving wind on the vehicle.

FIG. 1 depicts the system herein showing the plurality of recessed aerodynamic fans operatively engaged to an alternator or generator and a conduit system for channeling exhausting air to heat the vehicle, defrost or defog or device windows.

FIG. 2 is a top view graphic depiction of the air channeling and plurality of angles from which incoming air can turn the fan driving the alternator or generator and communicate through conduits for a secondary purpose.

FIG. 3 depicts a top plan view of a mode of the system showing a typical side intake system showing projecting fans which may be used in conjunction with recessed fans or alone.

FIG. 4 depicts a top plan view of a mode of the system showing employment of the system herein as a means to heat or cool a battery compartment of a vehicle.

FIG. 5 depicts a mode of the device herein, having deflectors which are rotatably positionable around axis of the intake aperture and intake conduit, to provide means to adjust to incoming wind direction to recessed fans.

### DETAILED DESCRIPTION OF THE PREFERRED EMBODIMENTS

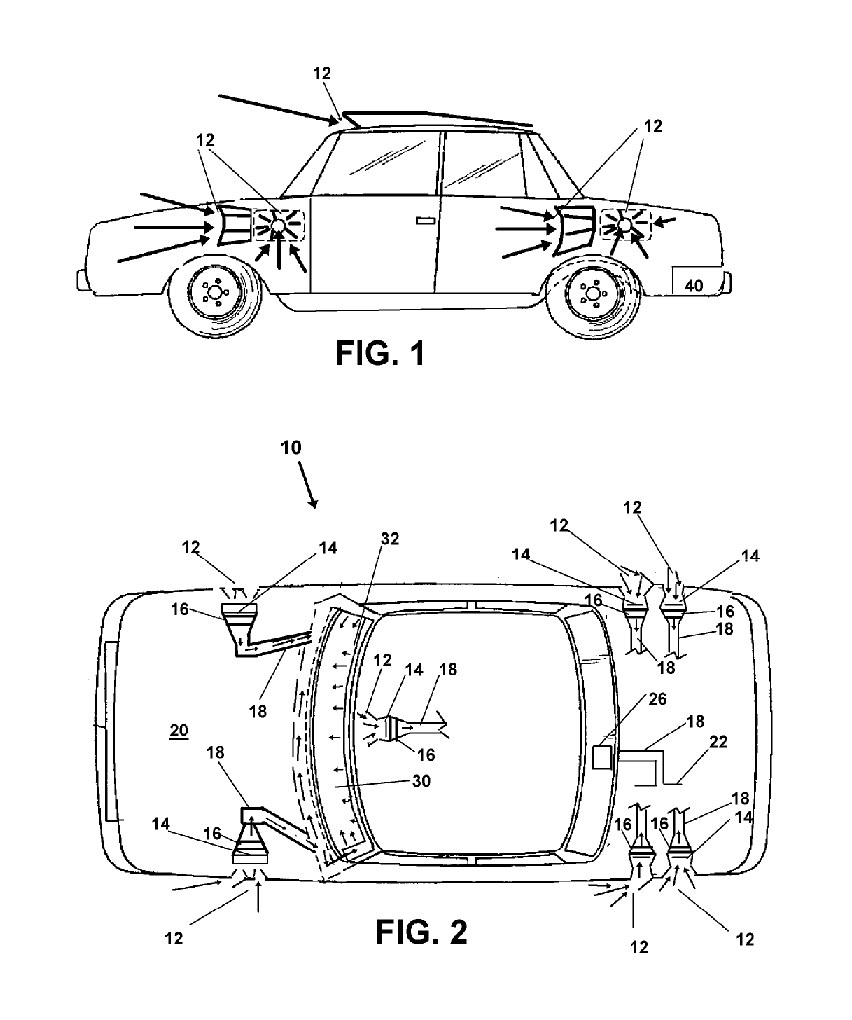

Referring now to the FIGS. 1-5, wherein similar components are depicted using like numerals for identification, in FIG. 1 there is shown a plurality of recessed or aerodynamic intake apertures 12 which may be used alone, or in combination with other modes which project or have deflectors 17 which are further described herein.

As noted, the air intakes 12 are positioned to take advantage of both airstreams available. First, the airstreams developed for and from the moving car which generally run inline with the vehicle's direction of travel. Second, the airstreams from wind approaching a parked vehicle at different angles.

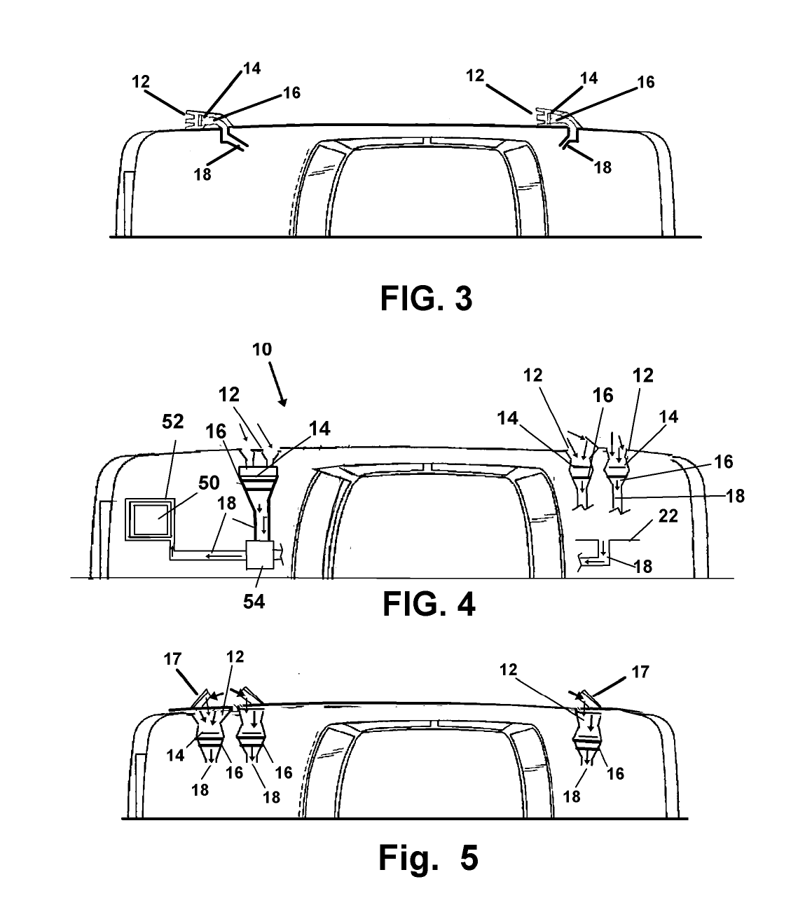

By situating intake apertures 12 facing the front and sides of the vehicle, two potential airstreams may be captured to generate electrical energy. The system 10 herein employing these apertures 12 at differing angles, communicates a plurality of airstreams to provide a rotational force to a plurality of rotatable fans 14 which are in operative positioning to receive the incoming moving air communicated to the intake conduits 18 from the intake apertures 12 as shown in FIG. 2 and FIG. 3. The force of the moving air upon the fans 14 is employed to rotate the power generation device 16 such as an alternator or generator. Exiting the generation portion of the system, the air follows exhaust conduits 18 exhausting the moving airstreams in a direction away from the fans 14. All the fans 14 are preferably operatively engaged to a power generation device 16 such as a high efficiency generator or alternator which itself is in an electrical communication with a battery to store power.

By employing a funnel like mouth at the entry apertures 12 to capture moving streams of air to power the fans 14 which rotate the power generation devices 16, a larger area of the moving airstream is captured and funneled to smaller cross sectional incoming conduits 18 communicating with the fan 14. An increase in airspeed is thereby achieved which is inversely proportional to the decrease in the conduits 18 cross sectional area at the intersection with the fan 14. Exit conduits 18 continue thereafter to communicate the moving airstreams to a final determined designation as noted below.

Once the airstream has traversed the fans 14 and thereby generated rotational power for the engaged power generation device 16, the stream continues down the communicating exit conduits 18 under pressure from the trailing incoming airstream pushing the entire fluid stream through the conduit 18 system.

The airstream in the conduits 18 exiting the power generation portion of the system, may be employed for heat transmission to the vehicle. In this mode, an exiting conduit 18 of air moving in a direction away from the fan 14, is communicated past a heat exchange engine 20 or to a communication with a portion of the engine exhaust system 22. In the case of the exhaust system 22, the heat exchange means may be the headers or exhaust pipes exiting the engine. Once traversed over the heated exchange engine 20 or exhaust system 22, the air stream is warmed considerably and may be piped to parts of the vehicle for secondary employment for instance through heating vents 26 in the passenger compartment. Alternatively, the heated air may be employed to defrost the windows such as the windshield 30 in a conventional fashion where moving air is directed to contact and blow across the windshield during inclement weather to provide a means to deflect the rain or snow therefrom. This function eliminates the need for electrically driven wipers and windshield heaters which use electricity and rob power and economy from vehicle operations.

Additionally, the heated air may be employed to heat the battery or battery compartment 50 of a vehicle. This novel application of the system herein will prove especially well adapted in combination with a hybrid or fully electric vehicle. Such vehicles have recently been found to suffer sever loss of driving range due to their batteries being chilled in cold weather. Further, when overheated such batteries are subject to explosion.

Employing the system herein, as graphically depicted in FIG. 4, a heat exchanging means, such as an insulated enclosed housing 52 for a battery (not shown) may be employed to warm the battery within. The housing 52 will receive heated air from a conduit 18 communicating with the battery compartment 50 of the vehicle for operative heating, or temperature maintenance of the battery. As noted, the enclosed housing 52 may also be heated using resistive electrical means such as a grid of wiring in the compartment or an electric blanket component.

Alternatively, in summer seasons, or geographic areas prone to hot weather, the power generating device 16 may be employed to power a compressor 54, operatively engaged with a heat sink, or similar means to cool the airstream moving within the conduit 18. So employed, the conduit 18 will communicate with the heat exchanging area to remove battery heat such as an enclosed housing 52 surrounding or engaged proximate to the battery compartment 50 of the vehicle. Communication of the cooled airstream will thereby provide a means for operative cooling of the battery. Again, with hybrid or fully electric vehicles, besides the potential for lost range from chilled batteries which are out of the model temperature range of operation, there is the substantial risk of explosion from overheated batteries. This risk is especially a problem with the currently employed lithium high-current batteries now being employed to power hybrid and electric vehicles.

In another mode for use of the flowing airstream provided by incoming air, the airstream may be heated depending upon its temperature, and communicated to a focused exit aperture 32 from exiting conduits 18, where the airstream will be blown across the windshield 30 during rain or snow to eliminate the need for electrically driven wipers. With a regulated temperature of the airstream so directed the system herein may also be employed to limit fogging and, melt ice collected on the windshield or prevent its formation.

It should be noted, and easily discerned by those skilled in the art, that electrical energy generated from the plurality of onboard fan-driven alternators or generators, may be operatively communicated by conventional wiring means to batteries 40 for storage or real time use. Such wiring means and intermediary voltage regulators and busses and the like are well known to those skilled in the art. Consequently, any such wiring system as would be employed by those skilled in the art, to communicate electrical power from one or the plurality of fan driven alternators or generators, to batteries or components, are considered within the scope of this application.

FIG. 5 shows another favored mode of the device herein, having deflectors 17 which are rotatably positionable around the axis of any intake aperture 12 to provide a means to adjust and capture wind approaching from a plurality of directions. These deflectors 17, as with the other components herein, may be combined with any intake aperture 12 of any mode of the device herein. The deflectors 17 are operatively engaged to a small electric motor (not shown) allowing rotational adjustment in real time. As such, employing adjustment by an onboard wind sensor operating the electric motors engaged to the deflectors 17, or a user employing a switch, a means to rotate the deflector 17 to best deflect the airstream into the intake aperture 12 and to maximize the wind energy to the fan 14 engaged to a power generating device 16 is provided. The deflectors 17 would be most useful when the vehicle is parked or stationary for long periods to maximize power generation by adjusting to incoming wind directions. The wind direction sensor would be a conventional wind driven device as widely available a variety of purposes such as small weather stations. Such devices have a small fan and rotate with wind direction and many conventionally generate a small electrical current which may be employed to power the small motor turning the deflector 17. Sensors engaged to the rotating deflector 17 would communicate with a controller which would connect power to the electric motor to rotate and position the deflectors 17 to best deflect incoming wind from a sensed direction. The wind direction sensor and controller are common products available at hobby and electronic stores and well known to those skilled in the art and need not be depicted.

It should again be noted, that while some drawings show recessed fans 14, and some show projecting fans 14, and some show deflectors 17, or scoops, that the different fan positioning, deflectors, scoops and the like, may be employed individually or in combinations to yield the maximized wind communication to the fan 14 and hence the most power generation for a vehicle and its intended or projected use and parking over time. As such, any combination of recessed or projecting fans 14 with or without deflectors 17 as would occur to those skilled in the art is anticipated within the scope of this invention and the claims.

Further, while all of the fundamental characteristics and features of the wind and airstream charging system for a vehicle herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the disclosed system and apparatus herein as defined by the following claims.

What is claimed is:

1. A passive vehicle electrical energy generation apparatus, comprising:
a plurality of fans rotatably mounted on said vehicle;
rotational means for generation of electricity operatively engaged to each of said fans;
said fans facing away from said vehicle in one or a plurality of directions from an imaginary center line running from a front to a rear of said vehicle;
rotation of said plurality of fans engaged to said rotational means for generation of electricity, by contact with wind communicated to said fans, thereby generating electrical energy;
said vehicle moving under power providing said fans with said rotation through a communication to said fans of wind moving passed said moving vehicle; and
said plurality of fans provided said rotation by a communication of natural wind from one or a plurality of approaching directions when said vehicle is stationary;
wiring means to communicate said electrical energy to a battery; and
whereby said rotation of said fans providing said vehicle with an auxiliary source of said electrical energy which is employable for powering said vehicle or powering engaged electrical components whether said vehicle is stationary or moving.

2. The vehicle electrical energy generation apparatus of claim 1 additionally comprising:
said wind contacting said fans first traversing an aperture engaged to a fan conduit communicating with said fan;
a deflector, said deflector formed by a member engaged at a first end, adjacent to said aperture, and extending at an angle traversing across said aperture, to a second end of said deflector;
means to rotate said first end around a circumference of said aperture whereby said deflector may be rotated to position a surface to deflect said wind into said aperture;
means discern a direction of approach of said wind;
a controller, said controller providing means to operate said means to rotate said first end of said deflector to optimally position said surface to intersect said wind in said direction of approach and deflect it into said aperture to said fan; and
whereby wind approaching said vehicle when stationary may be deflected into aperture through said fan conduit to said fan, by rotating said deflectors.

3. The vehicle electrical energy generation apparatus of claim 1 additionally comprising:
said rotational means for generation of electricity being an alternator or generator;
a conduit having a first end for channeling said wind exhausting from said fans engaged through said conduit to a second end; and
said second end in sealed communication with one or a plurality of secondary conduits leading to one or a plurality of wind employing components from a group including, a de-fogging component, a windshield defroster, a windshield de-icing component, a wind powered windshield wiper, a passenger heating system, a battery heating component, and a battery cooling compartment.

4. The vehicle electrical energy generation apparatus of claim 1 additionally comprising:
said rotational means for generation of electricity being an alternator or generator;
an exhaust conduit having a first end in sealed communication with said wind upon exhausting from said fans;
said wind being communicated as moving air to a second end of said exhaust conduit; and
said second end of said exhaust conduit in a sealed communication with a de-fogging component for window glass of said vehicle; and
said de-fogging component directing said moving air across said glass to remove or prevent a fogging thereof.

5. The vehicle electrical energy generation apparatus of claim 2 additionally comprising:
said rotational means for generation of electricity being an alternator or generator;
an exhaust conduit having a first end in sealed communication with said wind upon exhausting from said fans;
said wind being communicated as moving air to a second end of said exhaust conduit; and
said second end of said exhaust conduit in a sealed communication with a de-fogging component for window glass of said vehicle; and
said de-fogging component directing said moving air across said glass to remove or prevent a fogging thereof.

6. The vehicle electrical energy generation apparatus of claim 1 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication across an exhaust manifold of said vehicle; and
said exhaust conduit communicating said moving air across said exhaust conduit and into a passenger compartment of said vehicle to thereby provide a passenger heating system for said vehicle.

7. The vehicle electrical energy generation apparatus of claim 2 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication across an exhaust manifold of said vehicle; and
said exhaust conduit communicating said moving air across said exhaust conduit and into a passenger compartment of said vehicle to thereby provide a passenger heating system for said vehicle.

8. The vehicle electrical energy generation apparatus of claim 1 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication across an exhaust manifold of said vehicle; and
said exhaust conduit communicating said moving air across said exhaust conduit and into a compartment surrounding a battery employed in operation of said vehicle; and
whereby said moving air warmed by communication with heat from said exhaust manifold provides a means to heat said battery to a proper operating temperature.

9. The vehicle electrical energy generation apparatus of claim 2 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication with a surface of a heating element powered by said electrical energy;
said exhaust conduit communicating said moving air across said heating element and into a compartment surrounding a battery employed in operation of said vehicle; and
whereby said moving air warmed by communication with heat from said heating element provides a means to heat said battery while said vehicle is stationary.

10. The vehicle electrical energy generation apparatus of claim 1 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication a cooling element, said cooling element having a surface cooler than a temperature of said moving air; and
said exhaust conduit communicating said moving air across said cooling element and into a compartment surrounding a battery employed in operation of said vehicle; and
whereby said moving air cooled by communication with said cooling element, provides a means to cool said battery to a proper operating temperature.

11. The vehicle electrical energy generation apparatus of claim 2 additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication a cooling element, said cooling element powered by said electric energy and having a surface cooler than a temperature of said moving air; and
said exhaust conduit communicating said moving air across said cooling element and into a compartment surrounding a battery employed in operation of said vehicle; and
whereby said moving air cooled by communication with said cooling element provides a means to cool said battery while said vehicle is stationary.

2. The vehicle electrical energy generation apparatus of claim additionally comprising:
said rotational means for generation of electricity being an alternator or generator;
an exhaust conduit having a first end in sealed communication with said wind upon an exhausting from said fans;
said wind being communicated as moving air to a second end of said exhaust conduit; and
said second end of said exhaust conduit in a sealed communication with one or a plurality of secondary conduits leading to one or a plurality of moving air employing components from a group including, a de-fogging component, a windshield defroster, a windshield de-icing component, a wind powered windshield wiper, a passenger heating system, a battery heating component, and a battery cooling compartment.
